(19) United States
(12) Patent Application Publication
(10) Pub. No.: US 2015/0201762 A1
(43) Pub. Date: Jul. 23, 2015

(54) Suspension Device For Presenting Goods, Having A Current-Carrying Profiled Rail And Primary Support Which Can Be Hung Therein

(71) Applicant: Visplay International AG, Muttenz (CH)

(72) Inventor: Herbert Walter, Mullheim (DE)

(73) Assignee: Visplay International AG, Muttenz (CH)

(21) Appl. No.: 14/425,210

(22) PCT Filed: Jun. 4, 2013
(86) PCT No.: PCT/CH2013/000093

§ 371 Date: Mar. 2, 2015

(30) Foreign Application Priority Data
Sep. 3, 2012 (DE) 20 2012 008 355.4

(51) Int. Cl. A47F 5/08; A47B 96/14; A47B 57/06; A47F 5/10; H01R 25/14

(52) U.S. Cl. CPC A47F 5/0853; A47F 5/0807; A47F 5/10; H01R 25/145; A47B 57/06; A47B 96/14

(57) ABSTRACT

The invention relates to a suspension device for presenting goods, comprising first of all a profiled rail (1), into which an electrical profiled element (2) is inserted, through which electrical conductors (24) on an insulating base (20) extend. The electrical conductors are accessible via a passage (10) of the profiled rail (1) that opens to the outside. The suspension device further comprises a primary support (4) that can be hung in the profiled rail (1) and has an insertion section (41) that can be inserted into the passage (10). An adapter (5,6) is arranged on the primary support (4). Said adapter is designed to tap current on the electrical conductors (24) in order to operate an electrical load, in particular a lighting unit (7). An electrical supply line (79) extends from the adapter (5) to the lighting unit (7). The adapter (5, 6) has current collectors (54, 64) having resilient contacts (541,641), which are intended to tap current on the electrical conductors (24). The adapter (5, 6) is inserted in a recess (45) of the primary support (4), which recess extends from close to a suspension hook (411) on the insertion section (41) into an arm part (40) of the primary support (4). The contacts (541, 641) protrude from the adapter (5, 6) in a spring-loaded manner and can be pushed back into the adapter (5, 6) when the insertion section (41) is inserted into the passage (10). When the insertion section (41) is completely inserted into the passage (10) and the contacts are positioned congruently to the electrical conductors (24), the contacts (541, 641) are pressed against the electrical conductors (24) by the spring force. The spring mounting of the current collectors (54, 64) is based on the inherent resilience thereof.

### FIELD OF APPLICATION OF THE INVENTION

The present invention relates to a suspension device for presenting goods, having a profiled rail into which an electrical profiled element is inserted, electrical conductors which are accessible, for the purpose of tapping off by an adapter, via a passage in the profiled rail, which passage is open to the outside, running on said electrical profiled element. The suspension device further comprises a primary support which can be hung in the profiled rail and has an insertion part which can be pushed into the passage and is provided with the adapter. The current tap serves for operation of an electrical load, for example a lighting unit, which is provided on the secondary support which is supported by one or more primary supports. Possible secondary supports are, in particular, shelf boards.

### PRIOR ART

WO 01/43599 A1, for example, discloses profiled rails, which are designed for suspension devices, for horizontal arrangement, and primary supports which can be hung therein. A development from this is the device according to WO 03/070060 A1 in which a current-carrying profiled element is inserted and therefore power can be supplied to an electrical load, in particular a lamp, via an adapter. Primary supports in the form of shelf boards with an adapter fitted thereon or non-electrified carrying arms can be inserted into said profiled rail. Current-carrying structures of this type are also known from EP 2 110 057 A1 and EP 2 292 120 A1. WO 2012/009 822 A1 discloses a more recent version of a horizontal profiled rail of this kind with an inner electrical profiled element into which primary supports, which tap off power for supplying an electrical load by means of an adapter, can be hung.

Profiled rails for vertical arrangement and primary supports which can be hung therein are also already known from various documents, for example from DE 201 00 181 U1, EP 1 692 982 A2/A3, WO 2008/019 516 A1 and WO 2009/103 169 A1. A current-carrying profiled rail, which is intended to be vertically fitted and to receive primary supports, is disclosed in WO 2005/027 278 A1.

### OBJECT OF THE INVENTION

The invention is based on the object of further improving the electrified suspension device of the vertical type. This includes simplifying handling when hanging the primary supports in the current-carrying vertical rail and broadening the designs possible with the suspension device.

### DESCRIPTION OF THE INVENTION

The suspension device which is provided for presenting goods initially comprises a profiled rail into which an electrical profiled element is inserted, electrical conductors which are accessible via a passage in the profiled rail, which passage is open to the outside, running on said electrical profiled element on an insulation base. The suspension device further comprises a primary support which can be hung in the profiled rail and has an insertion portion which can be pushed into the passage. An adapter is arranged on the primary support, said adapter being intended for tapping off current from the electrical conductors for operation of an electrical load, in particular a lighting unit. An electrical supply line extends from the adapter to the lighting unit. The adapter has current collectors with spring-action contacts which are intended for tapping off current from the electrical conductors. The adapter is inserted into a cutout in the primary support, said cutout extending from close to a hanging lug on the insertion portion into an arm part of the primary support.

Special embodiments of the device will be described below:
the contacts project out of the adapter in a spring-mounted manner, can be pushed back into the adapter when the insertion portion is pushed into the passage, and the contacts are pressed against the electrical conductors by the spring force when the insertion portion is pushed completely into the passage and the contacts are congruently positioned with respect to the electrical conductors. The spring-mounting of the current collectors is also based on their inherent elasticity.

The current collectors are pieces of wire which are bent several times and which each have a bending section, at the very front the contacts in the form of a V-shaped bend, and at the rear a clamping region.

Two primary supports support a secondary support in the form of a shelf board, and a frame structure with two profiled rails is provided, wherein in each case one primary support is intended to be hung in one of the passages in the two profiled rails. As an alternative, two primary supports support a secondary support in the form of a shelf board, and a frame structure with at least one profiled rail is provided, wherein in each case one primary support is intended to be hung in one of the two passages in the same profiled rails.

The profiled rail has a meandering cross section and is made up of:
a) two parallel flank struts which face the front face;
b) a central fin which faces the front face centrally between the flank struts and is recessed in relation to the front edges of the flank struts, and has a vertical push-in channel which opens at the front and also has lateral groove contours;
c) a back strut to one side of which the central fin is attached to form a T-shape and from which two parallel back limbs extend toward the rear, said back limbs comprising a vertical screw channel which is situated on the back strut;
d) two parallel slot grids which are in each case arranged between a flank strut and the adjacent back limb in the back strut;
e) a wing which extends at a right angle from each flank strut in each case with an offset toward the rear;
f) an L-shaped tongue strip which is in each case fitted to the wing and on which clearances and tongues are provided in an alternating manner; and
g) in each case one passage which opens at the front and which, in principle, is delimited by the associated flank strut and the central fin.

Holes for fastening purposes are provided in the wings and the tongues.

### BRIEF DESCRIPTION OF THE APPENDED DRAWINGS

In the drawings:

FIG. 1A—shows a perspective front view of a wall structure with two profiled rails, panel elements which are joined therebetween, fitted with primary supports and secondary supports, which rest on said primary supports, in the form of shelf boards;

FIG. 1B—shows a perspective view of the structure according to FIG. 1A from below;

FIG. 2—shows a perspective view of a profiled rail from FIG. 1A with feed means, covering profiled element and cover;

FIG. 3A—shows a perspective view of a piece of a profiled rail from FIG. 1A, without feed means, covering profiled element and cover;

FIG. 3B—shows a cross section through the profiled rail according to FIG. 3A;

FIG. 4A—shows a perspective view of a piece of an electrical profiled element for the profiled rail from FIG. 1A;

FIG. 4B—shows a cross section through the electrical profiled element according to FIG. 4A;

FIG. 5A—shows a perspective plan view of the feed means from FIG. 2;

FIG. 5B—shows a perspective bottom view of the feed means according to FIG. 5A;

FIG. 5C—shows a perspective view of the feed means according to FIG. 5A, broken apart into a bottom part and a top part;

FIG. 6A—shows a perspective view of a piece of the covering profiled element from FIG. 2;

FIG. 6B—shows a cross section through the covering profiled element according to FIG. 6A;

FIG. 7A—shows a perspective plan view of a cover of a first variant from FIG. 1A;

FIG. 7B—shows a perspective bottom view of the cover according to FIG. 7A;

FIG. 7C—shows a perspective plan view of a cover of the second variant;

FIG. 8A—shows a perspective view of a piece of the profiled rail according to FIG. 3A with the electrical profiled element according to FIG. 4A inserted;

FIG. 8B—shows a perspective view of the structure according to FIG. 8A, with the covering profiled element fitted;

FIG. 9A—shows a perspective view of the structure according to FIG. 8B with the feed means according to FIG. 5A close by;

FIG. 9B—shows a perspective bottom view of the structure according to FIG. 9A, with the feed means fitted, from the front;

FIG. 9C—shows a perspective rear view of the structure according to FIG. 9B;

FIG. 9D—shows a plan view of the structure according to FIG. 9B;

FIG. 10A—shows a perspective front view of the top piece of the profiled rail from FIG. 2 with the inner electrical profiled element, the fitted covering profiled element and the cover of the first variant;

FIG. 10B—shows a perspective front view of a top piece of a profiled rail according to FIG. 3A with the inner electrical profiled element, the fitted covering profiled element and the cover of the second variant;

FIG. 10C—shows the enlarged detail X1 from FIG. 1A;

FIG. 10D—shows the cross section along line A-A in FIG. 10A;

FIG. 11A—shows a perspective bottom view of a secondary support in the form of a shelf board with a lighting unit and supported by two primary supports;

FIG. 11B—shows a perspective side view of an insertion part of the first variant of a primary support, with a transition to the arm part and an attached adapter of the first variant;

FIG. 11C—shows the enlarged detail X2 from FIG. 11A;

FIG. 11D—shows a partially exploded view of the structure according to FIG. 11C;

FIG. 11E—shows the structure according to FIG. 11B, with an insertion part of the second variant of a primary support;

FIG. 12A—shows a perspective plan view of a complete adapter of the first variant from FIG. 11C;

FIG. 12B—shows a perspective bottom view of the adapter according to FIG. 12A;

FIG. 12C—shows a perspective plan view of the adapter according to FIG. 12A, broken apart into a cover and base;

FIG. 12D—shows an exploded view of the adapter according to FIG. 12A;

FIGS. 13 to 16B: show the process of hanging a primary support with an insertion part of the first variant and an adapter of the first variant into the profiled rail with the internal electrical profiled element and the covering profiled element, in three phases in the form of basic illustrations;

FIG. 13—shows the initial phase: the insertion part with the adapter is moved toward the profiled rail;

FIG. 14—shows the intermediate phase: the structure according to FIG. 13, insertion part and adapter of the shelf board are partially inserted into the profiled rail;

FIG. 15—shows the final phase: the arrangement according to FIG. 14, insertion part and adapter are inserted into the profiled rail in the intended end position; and

FIG. 16A—shows a cross section through the structure and the situation according to FIG. 15, with panel elements attached to the profiled rail;

FIG. 16B—shows the enlarged detail X3 from FIG. 16A;

FIG. 17A—shows a perspective plan view of a secondary support in the form of a shelf board, supported by two primary supports which are arranged next to one another;

FIG. 17B—shows the secondary support with the primary supports according to FIG. 17A, hung in a bottom piece of a profiled rail according to FIG. 2;

FIG. 18—shows a basic illustration of the process of hanging a primary support with an insertion part of the second variant and an adapter into the profiled rail with the internal electrical profiled element and the covering profiled element;

FIG. 19A—shows a perspective bottom view of a secondary support in the form of a shelf board, having a lighting unit and supported by two primary supports;

FIG. 19B—shows a perspective side view of an insertion part of the first variant of a primary support, with a transition to the arm part and an attached adapter of the second variant;

FIG. 19C—shows the enlarged detail X3 from FIG. 19A; and

FIG. 19D—shows a partially exploded view of the structure according to FIG. 19C.

### EXEMPLARY EMBODIMENT

An exemplary embodiment for the suspension device according to the invention for presenting goods having the alternative details is described in detail below with reference to the appended drawings.

The following statement applies to the whole of the rest of the description. If reference numerals are contained in a figure for the purpose of graphical unambiguity, but are not explained in the directly associated text of the description, then reference is made to where they are explained in the preceding or following descriptions of the figures. In the interests of clarity, the repeated designation of components in further figures is generally omitted if it can be graphically unambiguously seen that these involve “repeating” components.

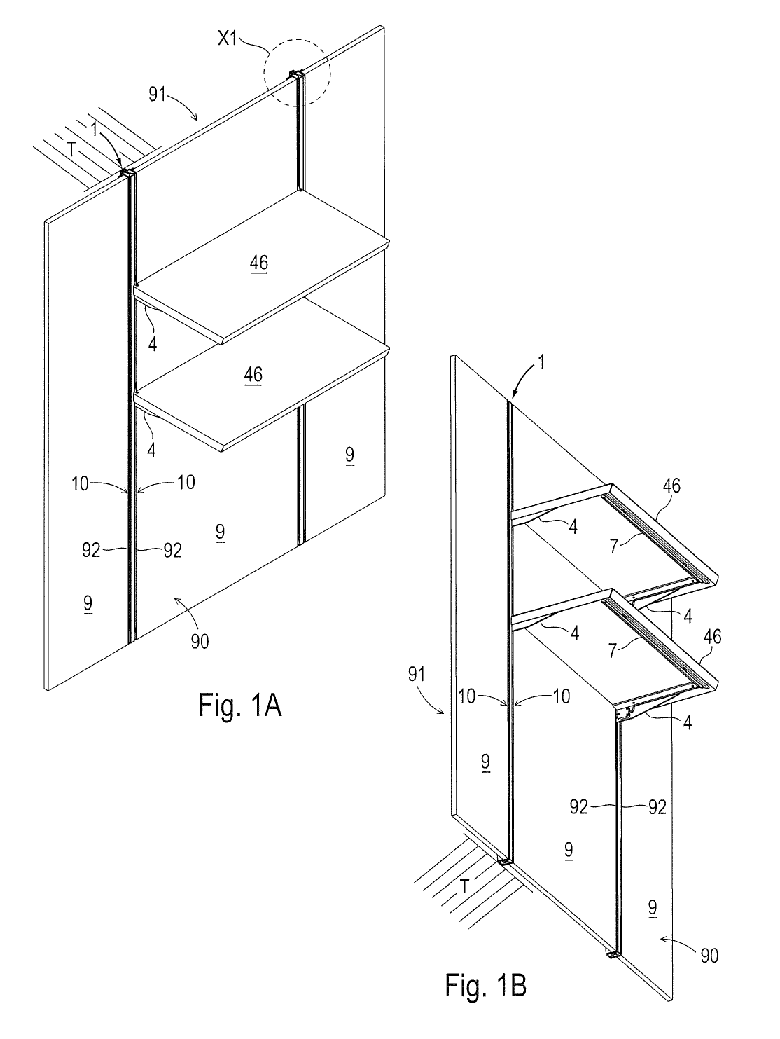

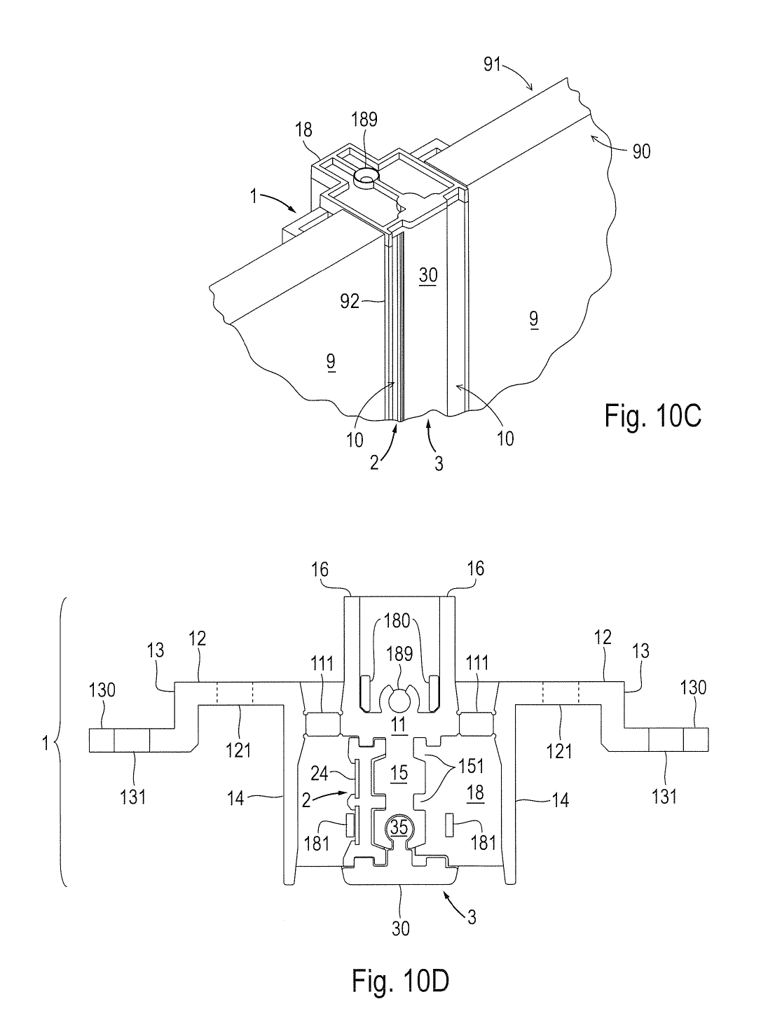

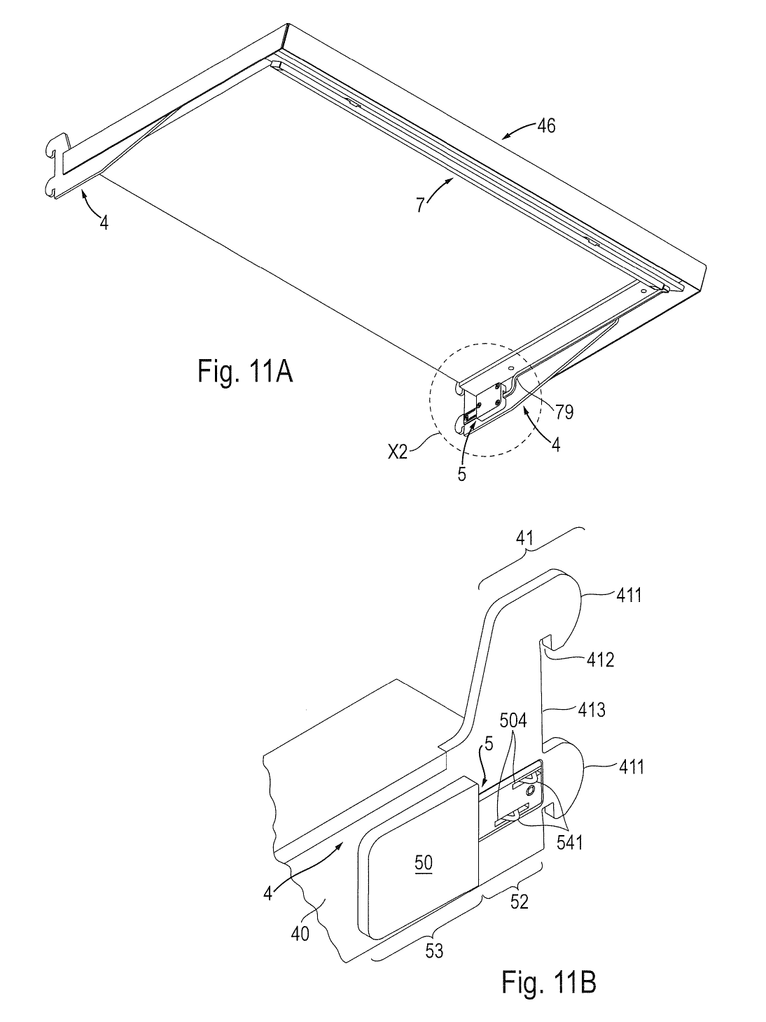

### FIGS. 1A, 1B and 10C

The wall structure comprises two profiled rails 1 which are arranged vertically and at a parallel distance from one another, and, in said profiled rails, primary supports 4 which bridge said profiled rails and support secondary supports 46 in the form of shelf boards. The longitudinal edges 92 of panel elements 9 are attached to the sides of the profiled rails 1, the front face 90 of said panel elements facing into the room, while the rear face 91 of said panel elements faces a supporting structure T, for example a building wall. Two passages 10 which run vertically and close to one another in parallel and into which the primary supports 4 can be hung lead into each profiled rail 1. A lighting unit 7 is installed on the bottom face of the secondary supports 46 in each case close to the front edge of said secondary supports. An electrical profiled element 2 is arranged in the interior of the profiled rail 1. Between the two passages 10, the profiled rail 1 is covered at the front by the transverse limb 30 of a covering profiled element 3. A cover 18 of the first variant, which can be fixed through a screw hole 189, is fitted at the very top of the profiled rail 1.

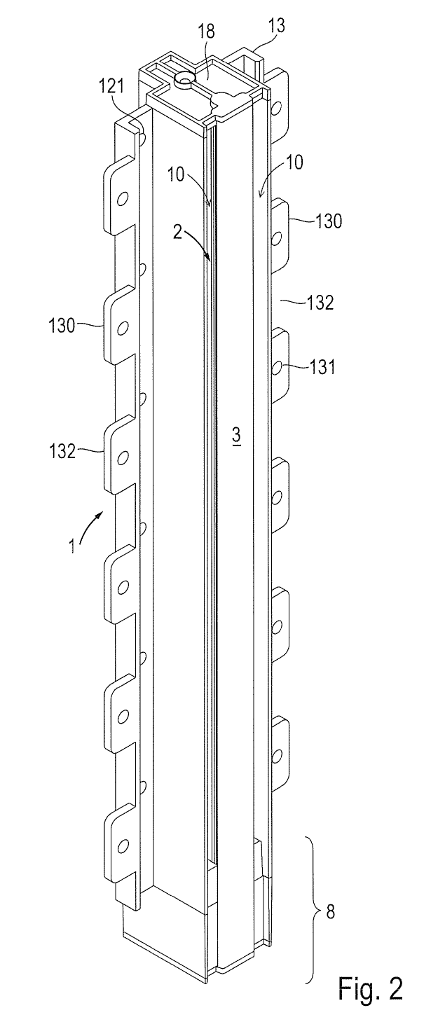

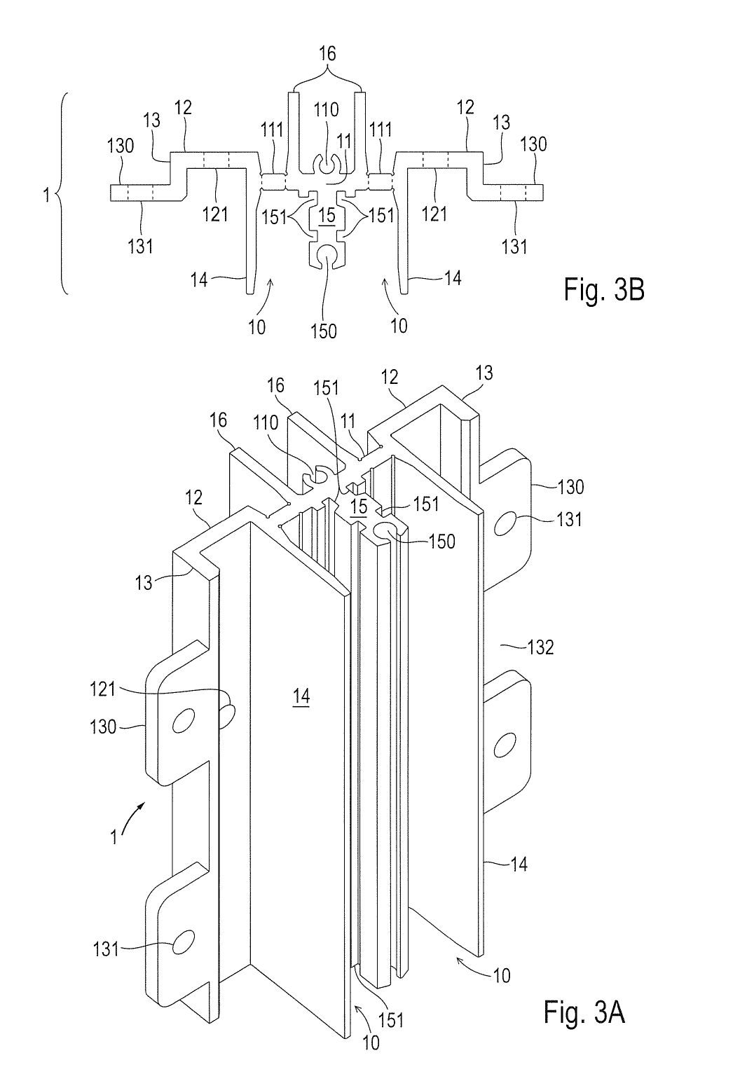

### FIGS. 2 to 3B

The block-like feed means 8 for the supply of power is fitted to the bottom end of the profiled rail 1, while the cover 18 of the first variant forms the termination at the very top. The profiled rail 1 has a meandering cross section and is made up of:
two parallel flank struts 14 which face the front;
a central fin 15 which faces the front centrally between the flank struts 14 and is recessed in relation to the front edges of the flank struts 14, and has a vertical push-in channel 150 which opens at the front and also has lateral groove contours 151;
a back strut 11 to one side of which the central fin 15 is attached to form a T-shape and from which two parallel back limbs 16 extend toward the rear, said back limbs comprising a vertical screw channel 110 which is situated on the back strut 11;
two parallel slot grids 111 which are in each case arranged between a flank strut 14 and the adjacent back limb 16 in the back strut 11;
a wing 12 which extends at a right angle from each flank strut 14 in each case with an offset toward the rear and in which holes 121 are provided for fastening purposes;
an L-shaped tongue strip 13 which is in each case fitted to the wing 12 and on which clearances 132 and tongues 130 are provided in an alternating manner, fastening holes 131 being located in said tongues; and
in each case one passage 10 which opens at the front and which, in principle, is delimited by the associated flank strut 14 and the central fin 15.

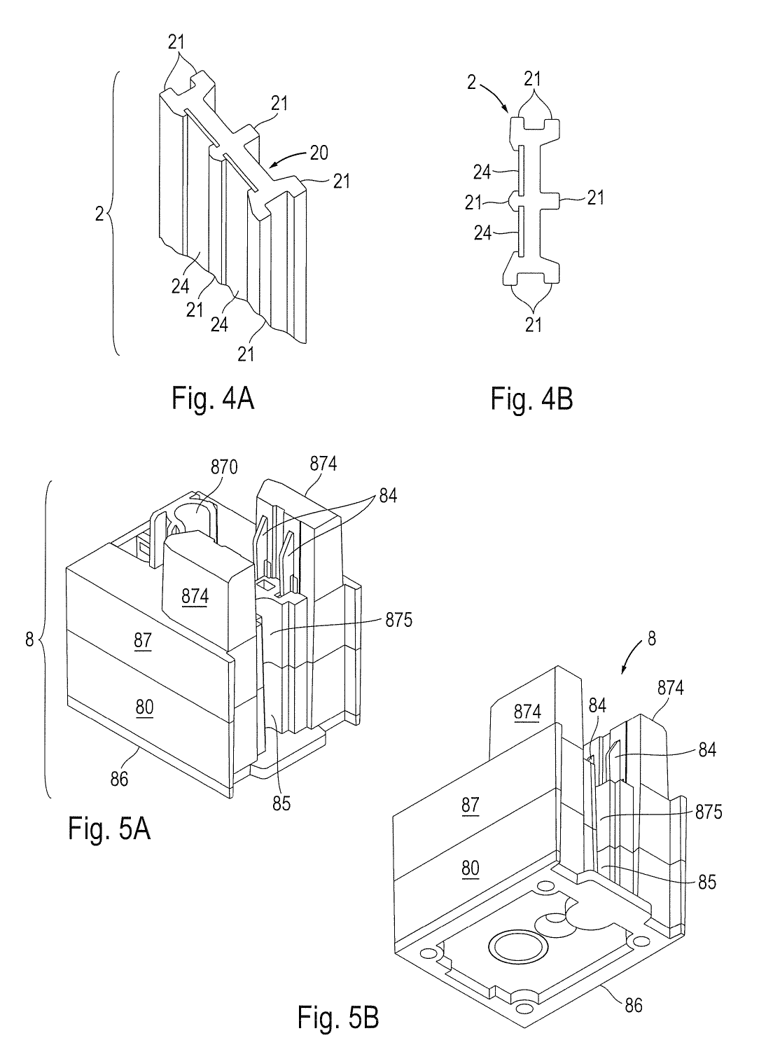

### FIGS. 4A and 4B

The electrical profiled element 2 comprises the strand-like insulation base 20 with its holding contours 21 and the two tape-like electrical conductors 24 which are partially embedded in the insulation base 20 and are arranged in a manner separated from one another.

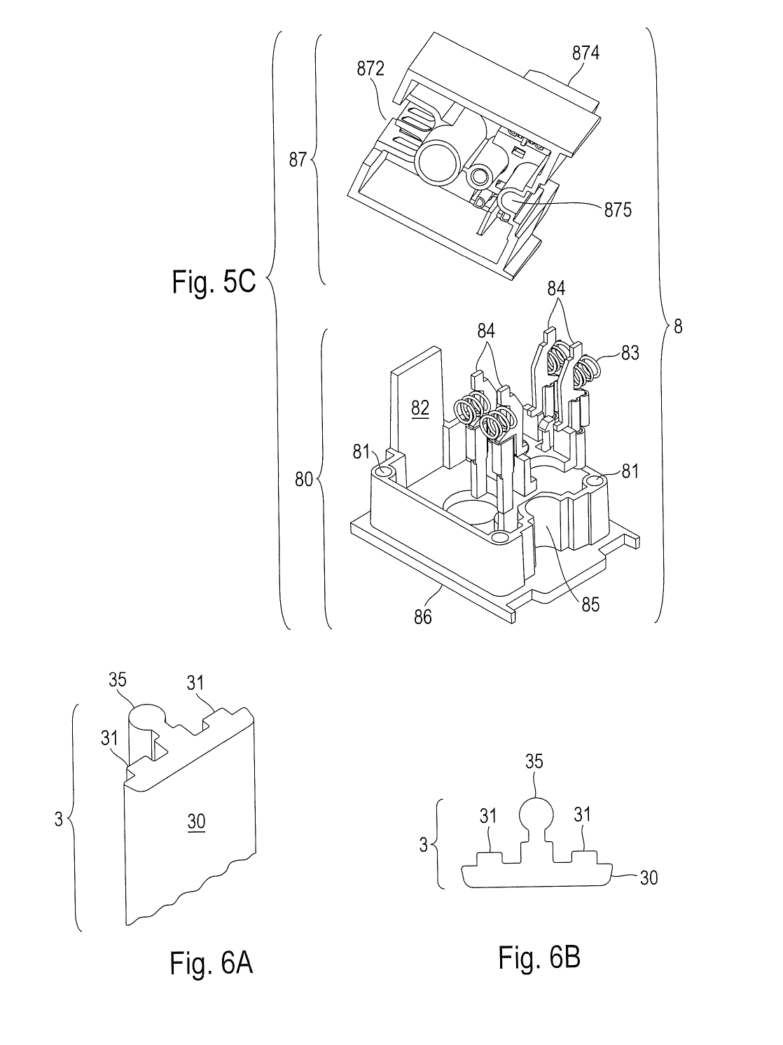

### FIGS. 5A to 5C

The feed means 8 is made up of a bottom part 80 and a top part 87 which is fitted onto said bottom part, wherein the two parts form the basic shape of a cube. The bottom part 80 has the base plate 86 from which a base structure protrudes, said base structure having screw holes 81 in the corners, a vertical back fin 82, the contact elements 84 and the springs 83 which are seated on said contact elements. The bottom part 80 has a vertically running groove 85 at the front. The top part 87 has the groove 875, which complements the groove 85, and the open area 872 for receiving the back fin 82. Two pegs 874, from which the spring-mounted contact elements 84 protrude, and the shell contour 870 for embedding the screw channel 110 of the profiled rail 1 protrude from the top part 81.

### FIGS. 6A and 6B

The strand-like covering profiled element 3 has, at the front, the transverse limb 30, the strip contours 31 and the round contour 35 being attached to the rear of said transverse limb.

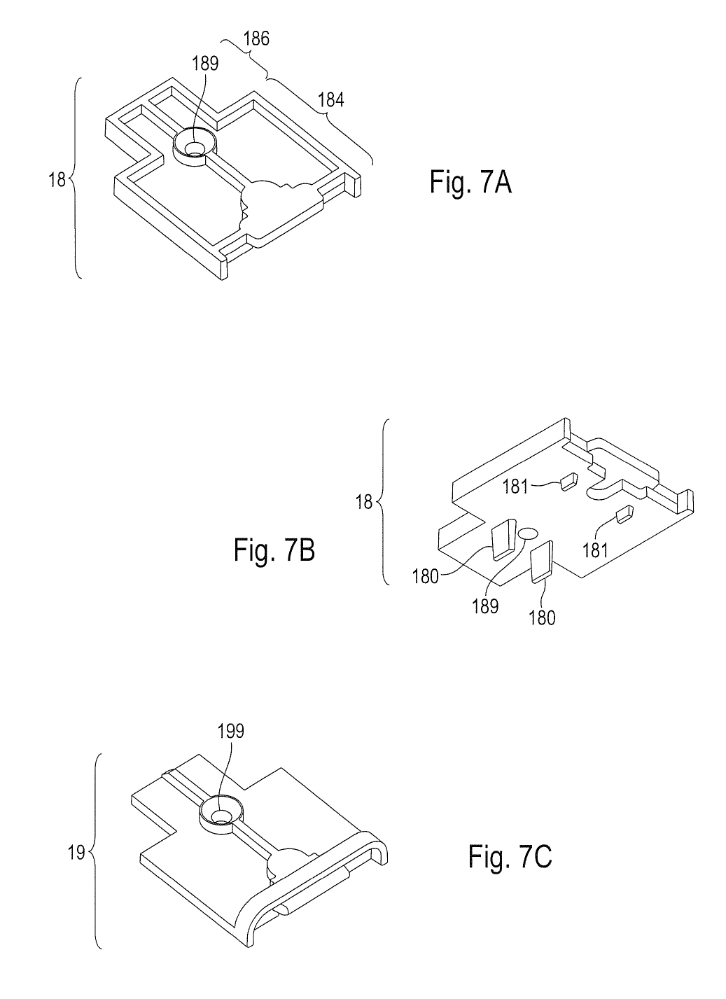

### FIGS. 7A, 7B, 10A and 10D

The cover 18 of the first variant (see FIGS. 7A, 7B) is intended for the top termination of the profiled rail 1 when said profiled rail extends over the entire height of the panel elements 9. The cover 18 has the approximately square front portion 184 and the back portion 186 of smaller dimensions which is attached to the rear, the screw hole 189 being located in said back portion. First positioning lugs 180 and smaller second positioning lugs 181 protrude from the bottom face. In the assembled state, the first positioning lugs 180 come to rest against the inside of the back limbs 16, and the second positioning lugs 181 come to rest against the electrical conductors 24. The screw hole 189 is aligned with the screw channel 110. The cover 19 of the second variant (see FIGS. 7C, 10B) with its rounded portion is used when the profiled rail 1, with respect to its height, ends within the panel elements 9.

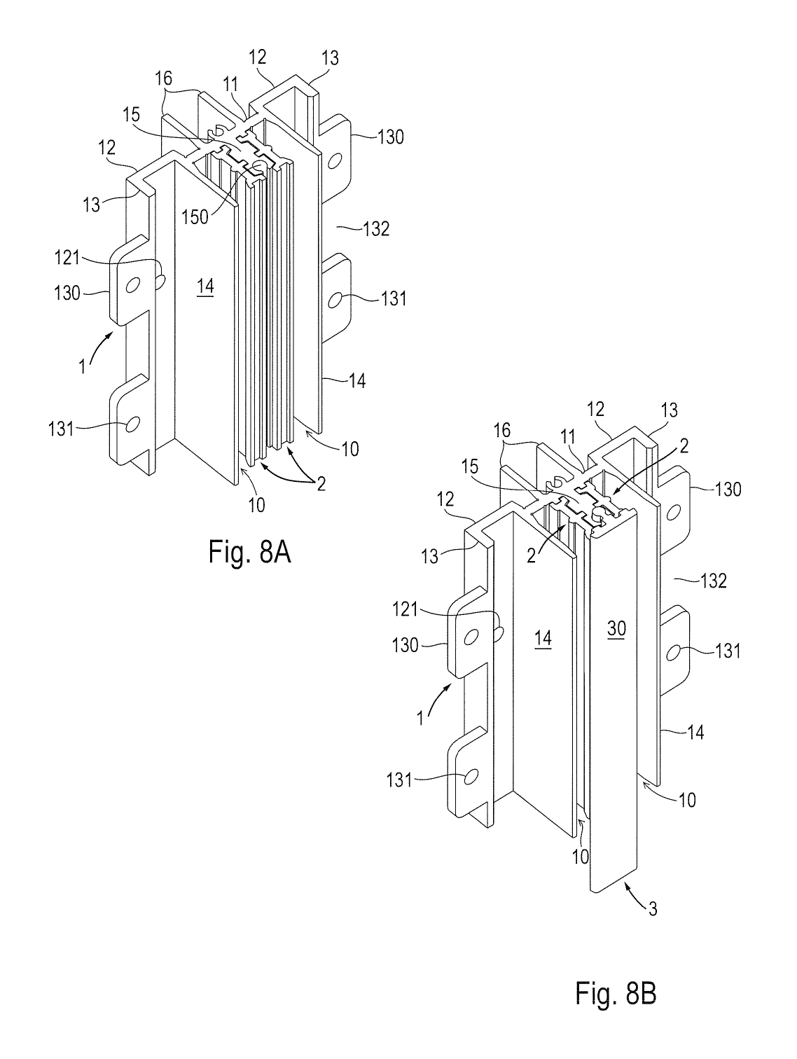

### FIGS. 8A and 8B

This pair of figures illustrates the interlocking insertion of the electrical profiled element 2 into the profiled rail 1 with the engagement of the holding contours 21 of the electrical profiled element 2 into the groove contours 151 of the profiled rail 1, so that the two electrical conductors 24 are each accessible via the associated passage 10. An electrical profiled element 2 can be inserted into both or only one of the passages 10. As an alternative, the second electrical profiled element 2 can be in the form of a control line, for example for switching functions on the lighting unit 7 or another signaling arrangement. At the front, the covering profiled element 3 is latched onto the profiled rail 1, so that the round contour 35 rests in the push-in channel 150 and the strip contours engage with the holding contours 21 of the electrical profiled element 2.

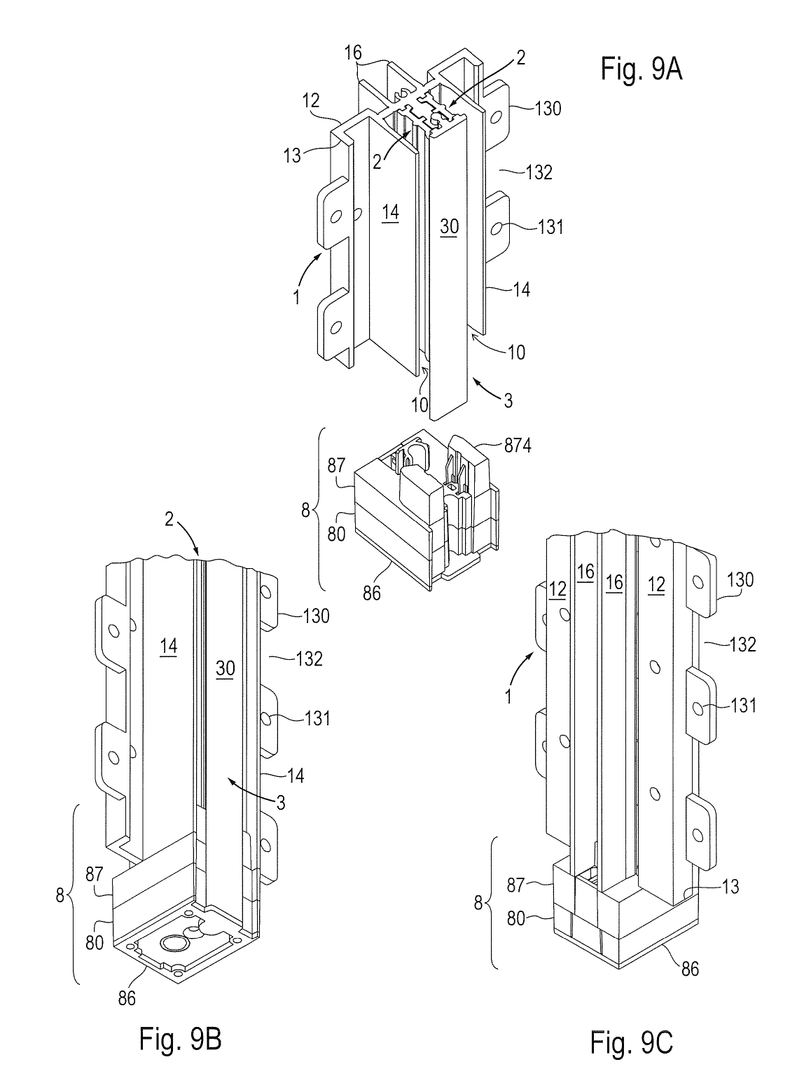

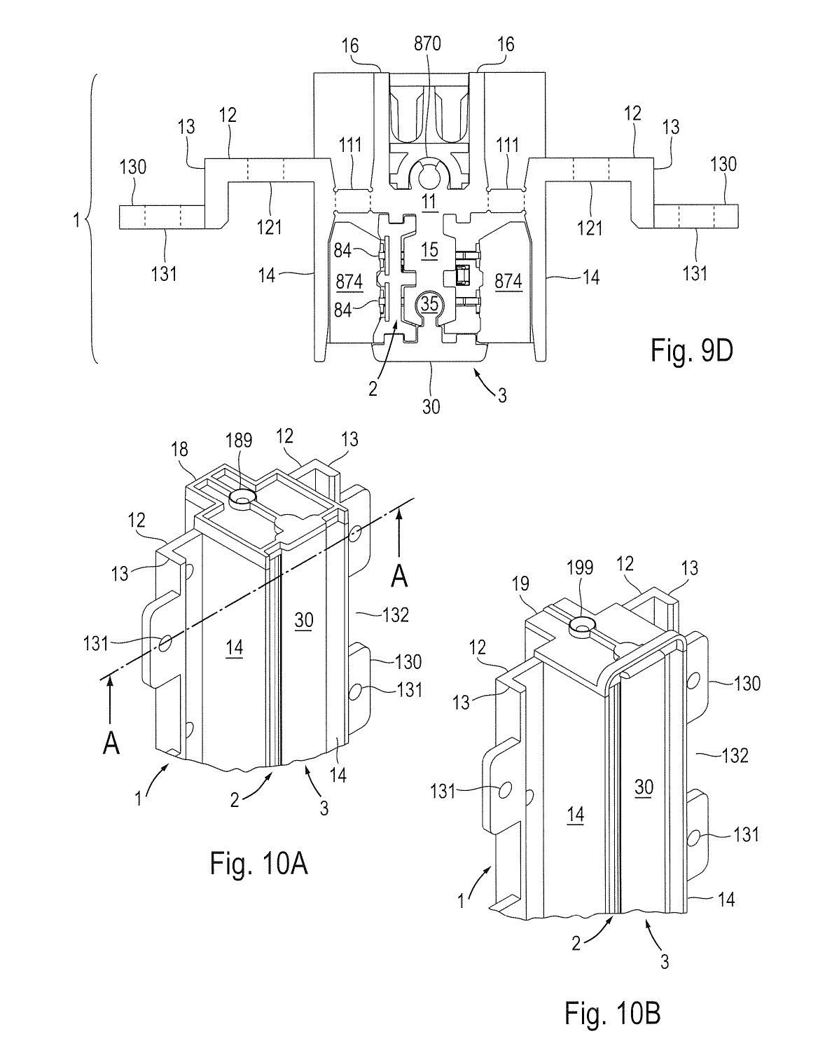

### FIGS. 9A to 9D

This sequence of figures illustrates the attachment of the feed means 8 to the bottom end of a profiled rail 1 with the covering profiled element 3 projecting into the feed means 8, the round contour 35 of the covering profiled element 3 coming to rest in the grooves 85, 875 in said feed means. The pegs 874 enter the passages 10, the contact elements 84 rest against the electrical conductors 24 and the screw channel 110 is surrounded by the shell contour 870.

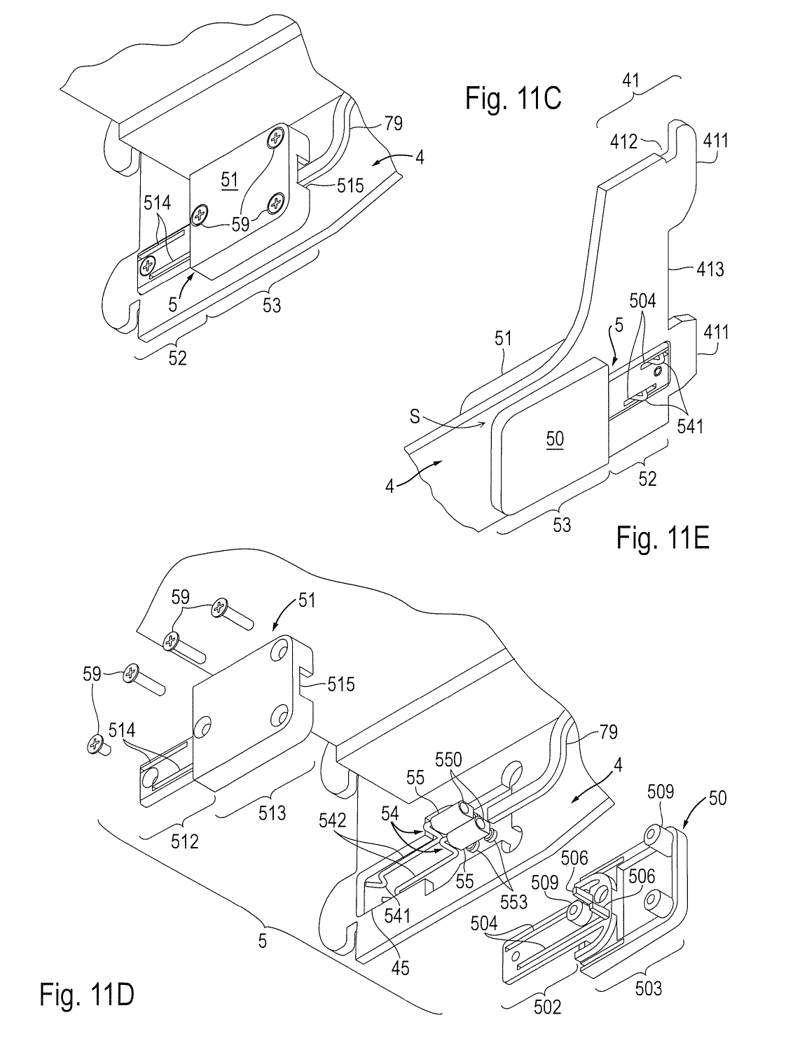

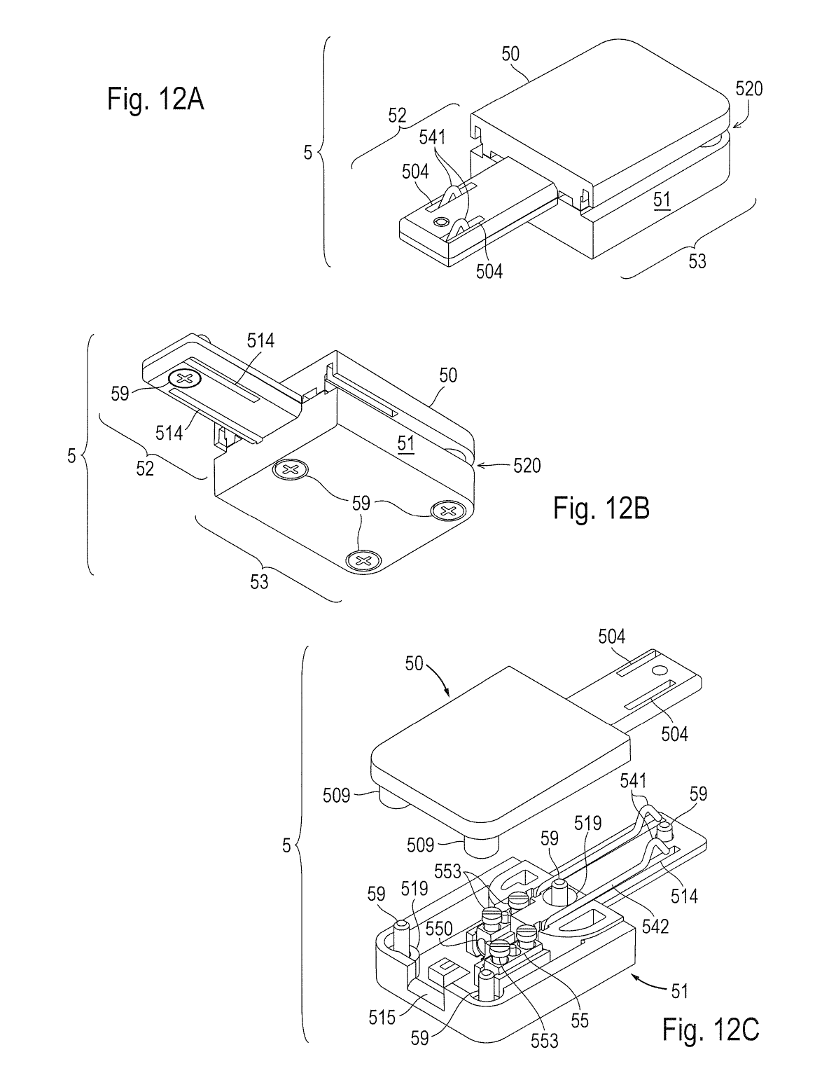

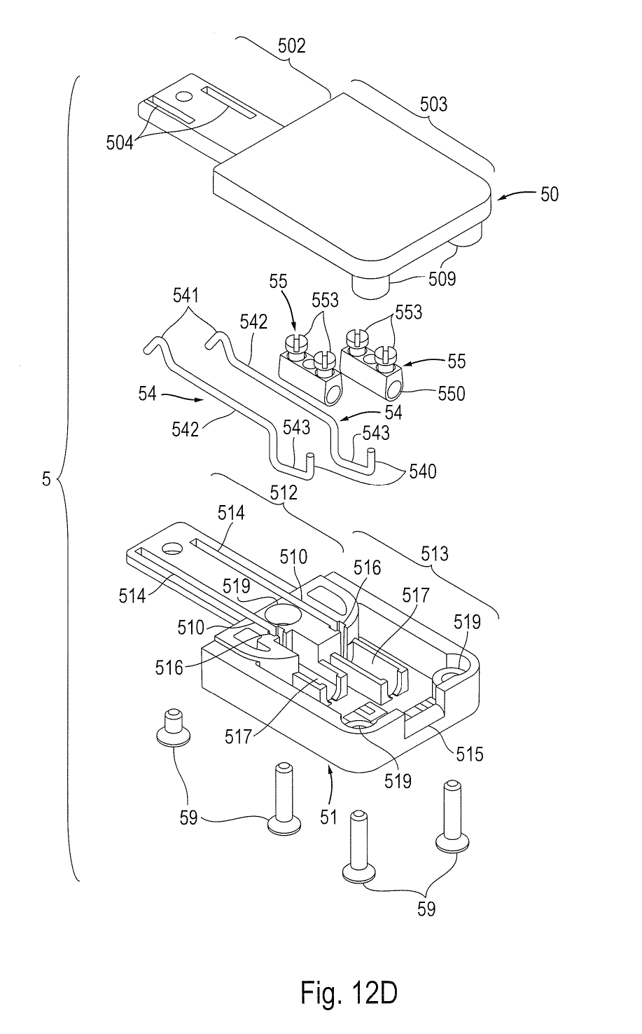

### FIGS. 11A to 12D

The secondary support 46, in the form of a shelf board here, is provided with a lighting unit 7 on the bottom face close to the front edge and is supported by two primary supports 4. A primary support 4 is fitted with an adapter 5 of the first variant, the supply line 79 extending from said adapter to the lighting unit 7. The geometry of the insertion part 41 in its first variant, which insertion part merges with the arm part 40 and together with it forms the primary support 4, is known per se with the lugs 411, the clearances 412 and the front edge 413. However, a cutout 45 for receiving the adapter 5 extends from the arm part 40 into the insertion part 41.

This adapter 5 comprises the cover 50 and the base 51, which together form a front part 52 and a rear part 53, wherein the slimmer front part 52 with the projecting contacts 541 projects into the insertion part 41 until it is level with the front edge 413 and adjoins the bottom lug 411. Cover 50 and base 51 are connected to one another by means of screws 59, threaded pegs 509 and screw holes 519. The base 51 has, in the rear part 513, for insertion of the supply line 79, a clearance 515, and, in the front part 512, cutouts 514 for receiving the current collectors 54 when these are pushed down. The cutouts 514 extend as incisions 510 into the rear part 513 of the base 51 in order to receive the bending sections 542 of the current collectors 54 therein. The cover 50 has, in the front part 502, groove-like apertures 504 so that the contacts 541 of the current collectors 54 can protrude. The front part 502 is adjoined by the rear part 503 which, in the screwed-together state, is joined to the rear part 513 of the base 51.

The two current collectors 54 are spring-action pieces of wire with the front contacts 541 which are bent in the shape of a V and which are each adjoined by a long and straight bending section 542 which merges with a clamping region 543 which is bent in the shape of a U. The clamping regions 543 are each fixed in a terminal 55 by the screws 553, the supply line 79 being fitted into the passage 550 in said screws from the rear. The cover 50 also has locking pins 506 which are intended to engage into undercuts 516 in the base 51. In the assembled state, the terminals 55 are situated in nests 517 in the base 51.

In the case of an insertion part 41 in its second variant (see FIG. 11E), the top lug 411 is directed upward, and the clearance 412 is situated at the top. The second, bottom lug 411 is not in the shape of a hook, but rather is in the form of a straight projection.

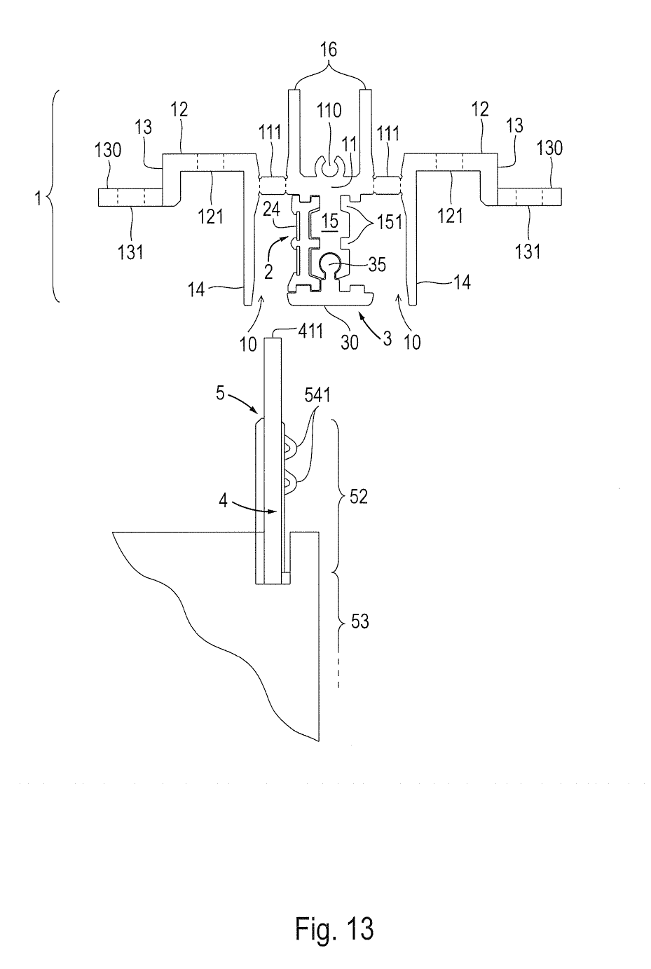

### FIGS. 13 to 16B

The process of inserting a primary support 4 into a profiled rail 1, provided with an electrical profiled element 2 and a covering profiled element 3, is illustrated in principle by means of this sequence of figures.

### FIG. 13 (Initial Phase)

The insertion part 41 with the adapter 5 of the first variant and the lugs 411 in front is oriented in alignment with one of the profiled rails 1. The contacts 541 protrude.

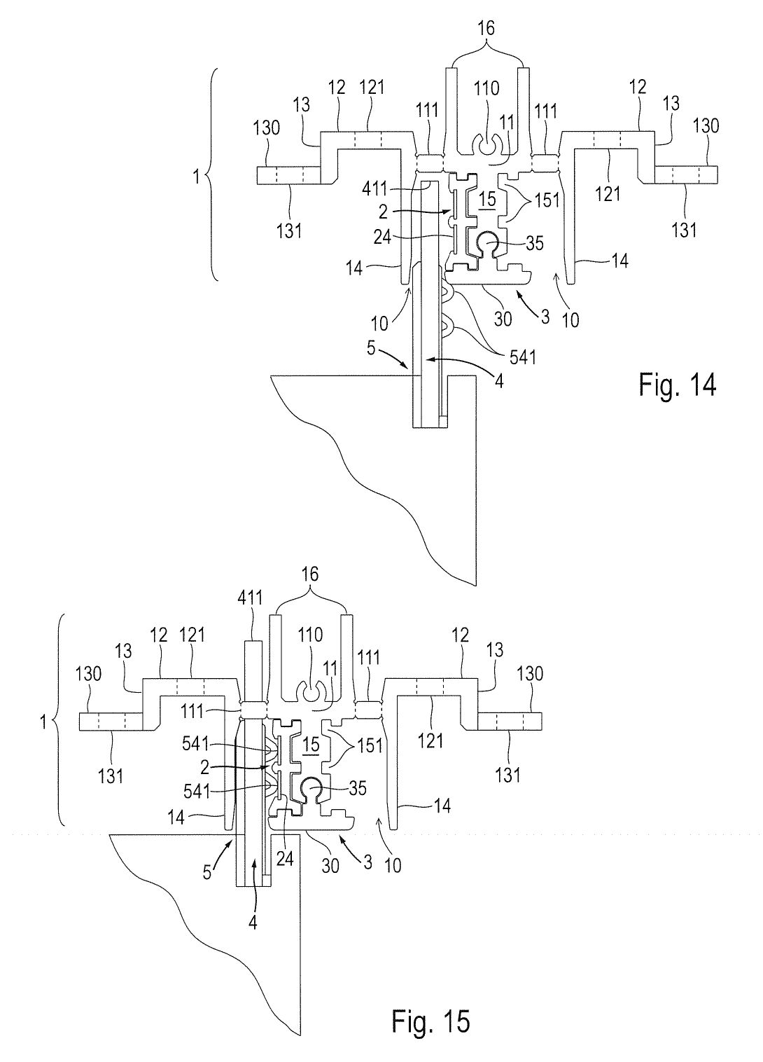

### FIG. 14 (Intermediate Phase)

When the insertion portion 41 is inserted into the passage 10, the contacts 541 meet the mouth of the passage and soon butt against the transverse limb 30 of the covering profiled element 3.

### FIG. 15 (Final Phase)

When the insertion portion 41 is pushed into the passage 10 to the maximum extent and the primary support 4 is lowered, the lugs 411 pass through the slot grid 111 and the clearances 412 hang on the wall fins on the back strut 11 which remain between the slot grid 111. When entering the passage 10, the contacts 541 were initially pushed in, but then pushed back again against the electrical conductors 24 with a spring action into the intermediate space. The process is reversed when the primary support 4 is pulled out of the profiled rail 1.

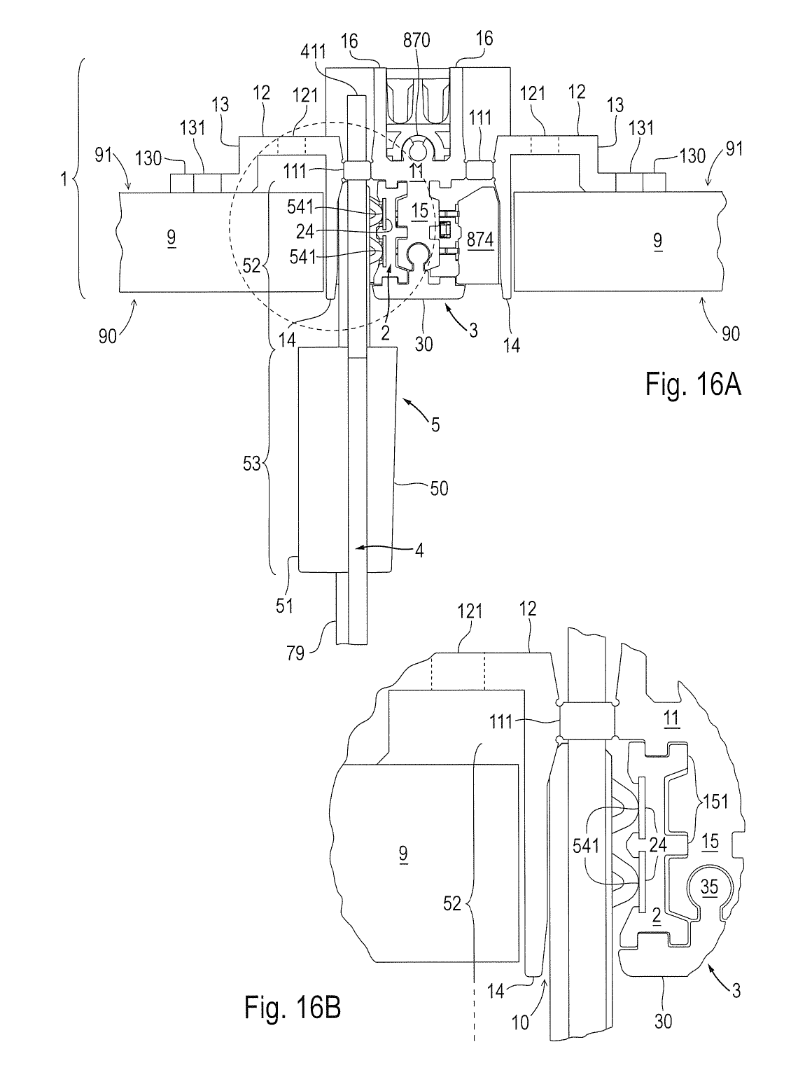

### FIGS. 16A and 16B

Here, panel elements 9 are joined to the sides of the flank struts 14 and can be fixed through the fastening holes 131 by means of screws.

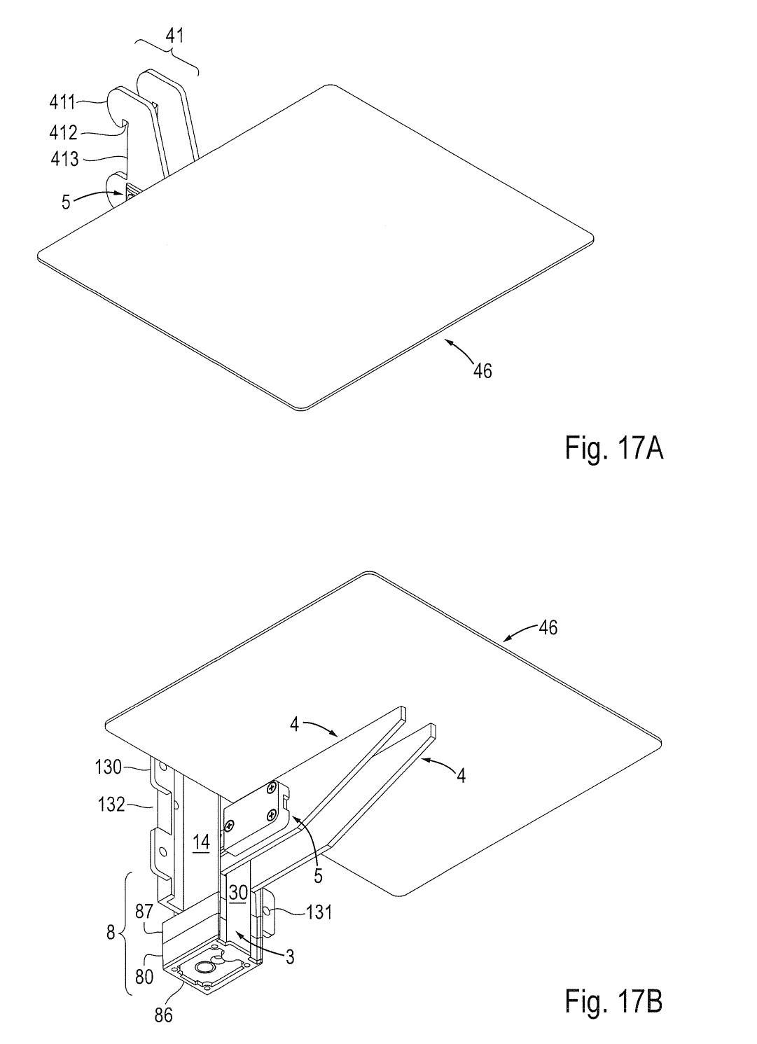

### FIGS. 17A and 17B

The secondary support 46 in the form of a shelf board is supported by two primary supports 4 which are arranged next one another, wherein only one of said primary supports is provided with an adapter 5 of the first variant. The lateral stability which is achieved with the design according to FIG. 11A is produced by the engagement into two profiled rails 1 which are spaced apart from one another, as shown in FIGS. 1A, 1B. In the case of the design according to FIGS. 17A, 17B, the lateral stability is achieved by hanging the two primary supports 4 in the two passages 10 in the same profiled rail 1.

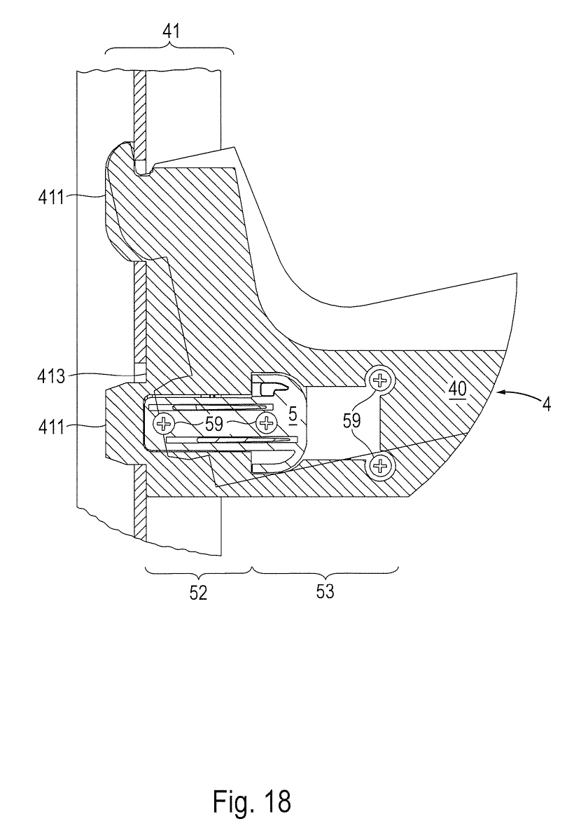

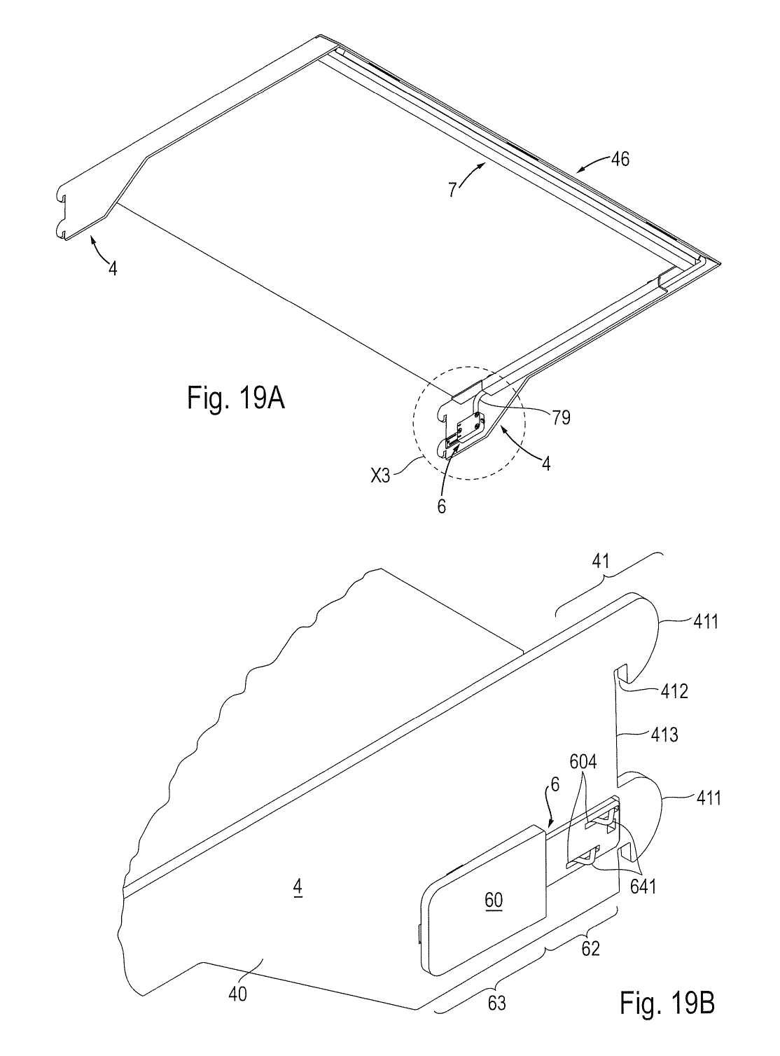

### FIG. 18

The process of hanging a primary support 4 with an insertion part 41 of the second variant and an adapter 5 of the first variant into the profiled rail 1 with the internal electrical profiled element 2 is illustrated here. Owing to the changed arrangement of the lugs 411, this primary support 5 has to be inserted into the passage 10 in an inclined manner and finally be pivoted into the horizontal position.

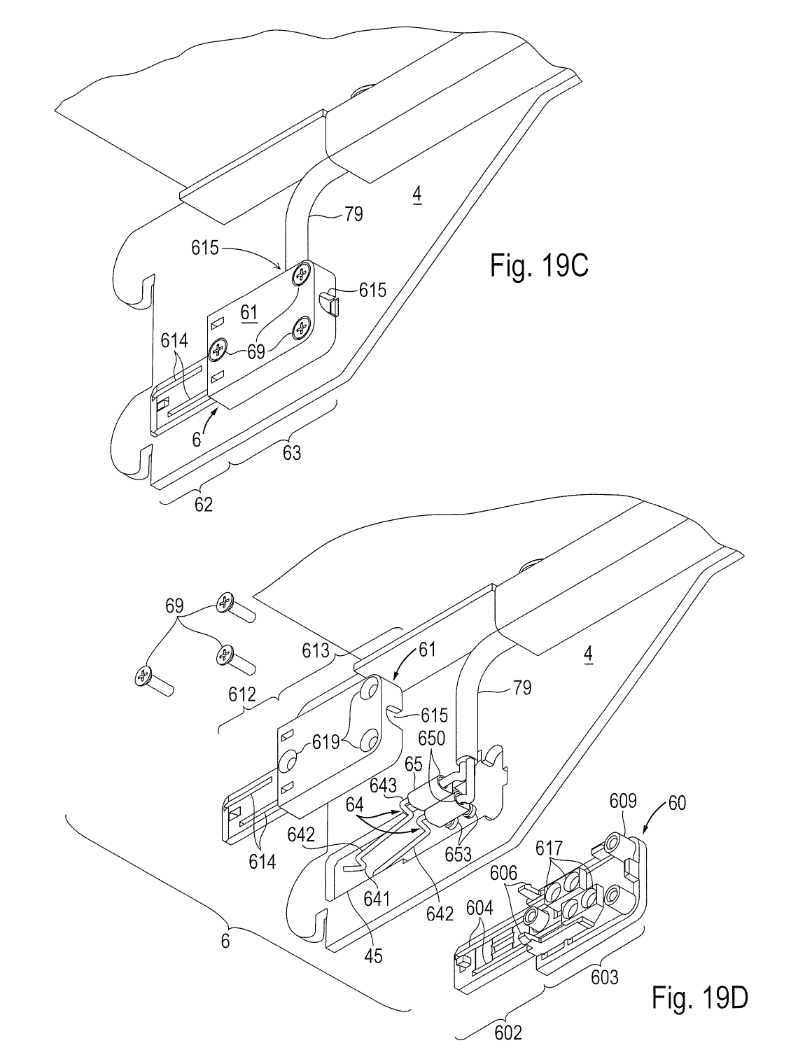

### FIGS. 19A to 19D

The secondary support 46, again in the form of a shelf board, is provided with the lighting unit 7 on the bottom face close to the front edge and is supported by two primary supports 4. One primary support 4 is fitted with an adapter 6 of the second variant, the supply line 79 running from said adapter to the lighting unit 7. The geometry of the insertion part 41 is unchanged in comparison to the sequence of FIGS. 11A to 11D. The cutout 45 which extends from the arm part 40 into the insertion part 41 serves to receive the adapter 6.

This adapter 6 of the second variant comprises the cover 60 and the base 61 which together form a front part 62 and a rear part 63, wherein the slimmer front part 62 with the projecting contacts 641 projects into the insertion part 41 until it is level with the front edge 413 and adjoins the bottom lug 411. Cover 60 and base 61 are connected to one another by means of screws 69, threaded pegs 609 and screw holes 619. The base 61 has, in the rear part 613, for insertion of the supply line 79, at least one clearance 615, and, in the front part 612, cutouts 614 for receiving the current collectors 64 when these are pushed down. The cutouts 614 extend as incisions into the rear part 613 of the base 61 in order to receive the bending sections 642 of the current collectors 64 therein. The front part 602 is adjoined by the rear part 603 which, in the screwed-together state, is joined to the rear part 613 of the base 61.

The cover 60 has, in the front part 602, groove-like apertures 604 so that the contacts 641 of the current collectors 64 can protrude. The two current collectors are spring-action pieces of wire with the front contacts 641 which are bent in the shape of a V and which are each adjoined by a long and straight bending section 642 which merges with an angled fixing region. The supply line 79 with its cables is routed to the passage 650 in the terminal 65 from the rear. The clamping region 643 of the respective current collector 64 is inserted into the terminal 65 from the front. The routed cable and the inserted clamping regions 643 are each fixed in the two terminals 65 by the screws 653.

The cover 60 also has locking pins 606 which are intended to engage into complementary contours on the base 61. In the assembled state, the terminals 65 are situated in nests in the base 61 and the screws 653 are situated in nests 617 which are present on the cover 60.

1. A suspension device for presenting goods, having:
a) a profiled rail (1) into which an electrical profiled element (2) is inserted, electrical conductors (24) which are accessible via a passage (10) in the profiled rail (1), which passage is open to the outside, running on said electrical profiled element on an insulation base (20);
b) a primary support (4) which can be hung in the profiled rail (1) and has an insertion portion (41) which can be pushed into the passage (10); wherein
c) an adapter (5, 6) is arranged on the primary support (4), said adapter being intended for tapping off current from the electrical conductors (24) for operation of an electrical load, in particular a lighting unit (7);
d) an electrical supply line (79) extends from the adapter (5, 6) to the lighting unit (7); and
e) the adapter (5, 6) has current collectors (54, 64) with spring-action contacts (541, 641) which are intended for tapping off current from the electrical conductors (24),
characterized in that
f) the adapter (5, 6) is inserted into a cutout (45) in the primary support (4), said cutout extending from close to a hanging lug (411) on the insertion portion (41) into an arm part (40) of the primary support (4).

2. The suspension device as claimed in claim 1, characterized in that
a) the contacts (541, 641) project out of the adapter (5, 6) in a spring-mounted manner, can be pushed back into the adapter (5, 6) when the insertion portion (41) is pushed into the passage (10), and the contacts (541, 641) are pressed against the electrical conductors (24) by the spring force when the insertion portion (41) is pushed completely into the passage (10) and the contacts are congruently positioned with respect to the electrical conductors (24); and
b) the spring-mounting of the current collectors (54, 64) is also based on their inherent elasticity.

3. The suspension device as claimed in either of claims 1 and 2, characterized in that the current collectors (54, 64) are pieces of wire which are bent several times and which each have a bending section (542, 642), at the very front the contacts (541, 641) in the form of a V-shaped bend, and at the rear a clamping region (543, 643).

4. The suspension device as claimed in one of claims 1 to 3, characterized in that two primary supports (4) support a secondary support (46) in the form of a shelf board, and a frame structure with two profiled rails (1) is provided, wherein in each case one primary support (4) is intended to be hung in one of the passages (10) in the two profiled rails (1).

5. The suspension device as claimed in one of claims 1 to 3, characterized in that two primary supports (4) support a secondary support (46) in the form of a shelf board, and a frame structure with at least one profiled rail (1) is provided, wherein in each case one primary support (4) is intended to be hung in one of the two passages (10) in the same profiled rails (1).

6. The suspension device as claimed in one of claims 1 to 5, characterized in that the profiled rail (1) has a meandering cross section and is made up of:
a) two parallel flank struts (14) which face the front face;
b) a central fin (15) which faces the front face centrally between the flank struts (14) and is recessed in relation to the front edges of the flank struts (14), and has a vertical push-in channel (150) which opens at the front and also has lateral groove contours (151);
c) a back strut (11) to one side of which the central fin (15) is attached to form a T-shape and from which two parallel back limbs (16) extend toward the rear, said back limbs comprising a vertical screw channel (110) which is situated on the back strut (11);
d) two parallel slot grids (111) which are in each case arranged between a flank strut (14) and the adjacent back limb (16) in the back strut (11);
e) a wing (12) which extends at a right angle from each flank strut (14) in each case with an offset toward the rear;
f) an L-shaped tongue strip (13) which is in each case fitted to the wing (12) and on which clearances (132) and tongues (130) are provided in an alternating manner; and
g) in each case one passage (10) which opens at the front and which, in principle, is delimited by the associated flank strut (14) and the central fin (15).

7. The suspension device as claimed in claim 6, characterized in that
a) holes (121) for fastening purposes are provided in the wings (12); and
b) holes (131) for fastening purposes are provided in the tongues (130).
